(19) United States
(12) Patent Application Publication
(10) Pub. No.: US 2013/0052420 A1
(43) Pub. Date: Feb. 28, 2013

(54) HIGH REPELLENCY FILMS VIA MICROTOPOGRAPHY AND POST TREATMENT

(71) Applicants: Shawn E. Jenkins, Duluth, GA (US); Ali Yahiaoui, Roswell, GA (US); Roger B. Quincy, III, Cumming, GA (US); Douglas P. Hoffmann, Suwanee, GA (US)

(72) Inventors: Shawn E. Jenkins, Duluth, GA (US); Ali Yahiaoui, Roswell, GA (US); Roger B. Quincy, III, Cumming, GA (US); Douglas P. Hoffmann, Suwanee, GA (US)

(21) Appl. No.: 13/214,954

(22) Filed: Aug. 22, 2011

(51) Int. Cl. D06N 7/04; B01D 39/16; A41D 13/00; A41D 13/12; B29C 67/24; A41D 19/015

(52) U.S. Cl. 428/143; 264/414; 2/167; 2/173; 2/69; 210/500.1

(57) ABSTRACT

A method is provided for making a high repellency material. In one embodiment the method includes the steps of providing a polymeric material having an external surface including particle-like micron-scale topography, etching the external surface with a high energy treatment; and depositing a fluorochemical onto the etched external surface by a plasma fluorination process. The external surface may define a plurality of micro-tears proximate the micron-scale topography.

### BACKGROUND OF THE INVENTION

Polymeric films are useful for a wide variety of applications, such as in personal care products, industrial garments, medical garments, medical drapes, sterile wraps, etc. It is not always possible, however, to produce these materials having all the desired attributes for a given application. For example, in some applications, materials need to have high repellency to avoid penetration of liquids such as oil, water, alcohol, blood, and so forth. In other applications, materials need to be breathable, for example, for comfort. Achieving the sufficient levels of repellency and breathability in polymeric films has heretofore been difficult.

Accordingly, there is a need for simple and inexpensive methods of making and/or treating polymeric films to be suitably repellent and/or breathable.

### SUMMARY OF THE INVENTION

In accordance with one embodiment of the present invention, a method of making a high repellency breathable material is provided, along with high repellency breathable materials made according to the process and personal care and other products containing the high repellency materials. The method includes the steps of: providing a polymeric material having an external surface, the external surface including particle-scale microtopography; etching the external surface with a high energy surface treatment; and depositing a fluorochemical onto the etched external surface by a plasma fluorination process.

In one embodiment, the polymeric material may include between about 1 and about 75 weight percent of a micron-sized particle, such as, for example, calcium carbonate. In other embodiments, the polymeric material may include between about 45 and about 75 weight percent of the micron-sized particles, or between about 45 and about 65 weight percent of the micron-sized particles. The polymeric material may further include between about 25 and about 99 weight percent of a base polymer, or between about 25 and about 55 weight percent of a base polymer, or between about 35 and about 55 weight percent of a base polymer. The base polymer may include several different polymers. The base polymer may be a polyolefin, for example, polyethylene, polypropylene, polybutylene, and so forth. For example, the polymeric material may be in the form of a breathable film.

In one embodiment, the step of providing the polymeric material may include a step of blending the micron-sized particles with the base polymer to form a blend, followed by extruding the blend into the polymeric material having the external surface. In another embodiment, the step of providing the polymeric material may include a step of applying a micron-sized particle treatment to the external surface of the polymeric material. In a further embodiment, the step of providing the polymeric material may include a high energy surface treatment.

In one embodiment, the high energy surface treatment may be a plasma treatment. The plasma may, for example, include a blend of an inert gas and a reactive gas. As another example, the plasma may include a blend of oxygen and argon, for example from about 1 to about 4 parts by weight oxygen and from about 1 to about 4 parts by weight argon.

In one embodiment, the fluorochemical may include fluoracrylate monomer.

In one embodiment, the high repellency material may be stretched to form micro-tears in the external surface of the material proximate the particle-scale micro-topography.

In accordance with one embodiment of the present invention, a high repellency synthetic polymeric article is provided. The article has particle-like micron-scale topography on an external polymeric surface of the article and a fluorochemical applied by plasma deposition. The external polymeric surface demonstrates a contact angle to water of greater than 140 degrees. In one embodiment, the article is a film. In one embodiment, the external surface of the article defines micro-tears proximate the particle-scale micro-topography.

In accordance with one embodiment of the present invention, a method of making a high repellency material includes the steps of: providing a polymeric material having an external surface; etching the external surface with a high energy treatment; applying a micron-sized particle surface treatment formulation to the etched external surface of the polymeric material; and thereafter applying a fluorochemical onto the micron-sized particle surface treatment. In a further embodiment, the micron-sized particle surface treatment formulation may include micron-sized calcium carbonate particles. In another further embodiment, the high energy treatment may include plasma treatment. In an even further embodiment, the fluorochemical may include fluoracrylate monomer.

In accordance with another embodiment, a high repellency synthetic film includes a polymer and inorganic particles, the inorganic particles providing particle-scale topography on an external surface of the article, the particle-scale topography having thereon a second topography having a smaller scale than the particle scale topography. In one aspect, the inorganic particles are calcium carbonate particles. In another aspect, the inorganic particles comprise greater than 40 wt. percent of the article. In a further aspect, the polymer may be a thermoplastic polyolefin.

In one aspect, the second topography is created by plasma deposition. In another aspect, the second topography has thereon a fluorochemical applied by plasma deposition. In a further aspect, the film comprises a silica-containing layer between the fluorochemical and the second topography. The silica-containing layer may be applied by plasma deposition.

In one aspect, the external surface of the film demonstrates a contact angle to water of greater than 125 degrees. In another aspect, the external surface of the film demonstrates a contact angle to isopropyl alcohol of greater than 60 degrees. In some embodiments, the film is breathable. In other embodiments, the the film demonstrates Water Vapor Transmission Rate (WVTR) of greater than 1000 grams per square meter per day.

In one aspect, the external surface of the film comprises micro-tears proximate the particle-scale topography.

In one aspect, the film may include POSS.

In one aspect, the film may be included in a personal care product, a filter, or a protective garment. The protective garment may be gloves, face masks, gowns, safety apparel, medical apparel, medical drapes, and so forth.

In one embodiment, a method of making a repellant material includes the steps of: providing a polymeric material having an external surface, the external surface including particle-like micro-topography; stretching the material to define a plurality of micro-tears proximate the micro-topography; etching the external surface with a high energy surface treatment; and depositing a fluorochemical onto the etched external surface by a plasma fluorination process. In one aspect, the polymeric material may include one or more base polymers and a plurality of particles. In another aspect, the particles may be calcium carbonate particles.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 depicts a graph showing breathability values for example films;

FIG. 2 depicts Scanning Electron Micrographs (SEMs) of an example film;

FIG. 3 depicts SEMS of another example film;

FIG. 4 depicts a graph showing contact angles for example films;

FIG. 5 depicts SEMs of the example film from FIG. 2 following plasma fluorination of the example film;

FIG. 6 depicts SEMs of the example film from FIG. 3 following plasma fluorination of the example film;

FIG. 7 depicts SEMS of examples films following plasma fluorination of the example films;

FIG. 8 depicts SEMS of an example film;

FIG. 9 depicts SEMS of the example film from FIG. 2 following plasma etching;

FIG. 10 depicts SEMS of the example film from FIG. 3 following plasma etching.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment may be used in or on another embodiment to yield a still further embodiment. Thus, it is intended that the present invention cover such modifications and variations.

The high repellency breathable film materials of the present invention may be prepared from any of a variety of film-forming polymeric materials. The polymer films may be formed by any of the conventional processes for forming films. The process will typically include extrusion of a polymer or blend of polymers by a conventional extruder into the desired film. The extrusion temperature may generally vary depending on the type of polymers employed. For example, a molten thermoplastic material may be fed from the extruders through respective polymer conduits to a conventional film die. Suitable polymers, alone or in combination with other polymers, include, by way of example only, polyolefins such as, for example, polyethylene, polypropylene, linear low density polyethylene, and polybutylene, ethylene vinyl acetate (EVA), ethylene ethyl acrylate (EEA), ethylene acrylic acid (EAA), ethylene methyl acrylate (EMA), ethylene normal butyl acrylate (EnBA), polyester, polyethylene terephthalate (PET), nylon, ethylene vinyl alcohol (EVOH), polystyrene (PS), polyurethane (PU), polybutylene (PB), polyether esters, polyether amides, and polybutylene terephthalate (PBT).

The high repellency material is suitably formed with a surface characterized by a high degree of micron-scale topography. Micron-scale topography may be achieved by various processes, including addition of an internal additive during extrusion, etching of an external surface following extrusion, and/or deposition of a micron-scale particle coating to the external surface following extrusion, combinations thereof, and so forth. The micron-scale topography is characterized by the presence on the surface of particle-like surface features. The micron-scale particle-like surface features may range in size (measured by largest dimension) from about 1 microns to about 100 microns, more specifically from about 1 microns to about 50 microns, and even more specifically from about 1 microns to about 30 microns, and even more specifically from about 1 micron to about 5 microns. The particle-like surface features having size (measured by largest dimension) greater than or equal to 1 micron may further have a surface density of from about 50 particle-like surface features per square millimeter to about 500,000 particle-like surface features per square millimeter, more specifically from about 500 particle-like surface features per square millimeter to about 350,000 particle-like surface features per square millimeter, and even more specifically from about 1,000 particle-like surface features per square millimeter to about 250,000 particle-like surface features per square millimeter.

Micron-scale topography on an external surface of synthetic polymer films may be achieved by using an internal particulate or agglomerate, such as, for example, micron-scale calcium carbonate particles. Various micron-scale calcium carbonate materials are available, for example, from Imerys Group and Omya Worldwide Group. Suitable particulates or agglomerates may be organic or inorganic, and are desirably in a form of individual, discrete particles. Suitable inorganic particulate or agglomerate materials include metal oxides, metal hydroxides, metal carbonates, metal sulfates, various kinds of clay, zeolite, fly ash, silica, titania, alumina, powdered metals, glass microspheres, or vugular void-containing particles. Particularly suitable particulate or agglomerate materials include calcium carbonate, barium sulfate, sodium carbonate, magnesium carbonate, magnesium sulfate, barium carbonate, kaolin, carbon, carbon black, graphite, graphene, and other predominantly carbonaceous solids, calcium oxide, magnesium oxide, aluminum hydroxide, and titanium dioxide. Still other inorganic fillers may include those with particles having higher aspect ratios such as talc, mica and wollastonite. Suitable organic particulate or agglomerate materials include, for example, latex particles, particles of thermoplastic elastomers, pulp powders, wood powders, cellulose derivatives, chitin, chitosan powder, powders of highly crystalline, high melting polymers, beads of highly crosslinked polymers, organosilicone powders, separated phases of incompatible polymers, and powders or particles of super absorbent polymers, such as polyacrylic acid and the like, as well as combinations and derivatives thereof.

The filled films may be made breathable by subjecting the film to a selected plurality of stretching operations, such as uniaxial stretching operation or biaxial stretching operation. Stretching operations may provide microporous films with a distinctive porous morphology and may enhance water vapor transport through the film. In a first embodiment, the film may be stretched from about 100 to about 1000 percent of its original length. In another embodiment, the film may be stretched from about 100 to about 800 percent of its original length, an in a further embodiment the film may be stretched from about 200 to about 600 percent of its original length.

The parameters during stretching operations include stretching draw ratio, stretching strain rate, and stretching temperature. Stretching temperatures may be in the range of from about 15° C. to about 100° C. In another embodiment, stretching temperatures may be in the range of from about 25° C. to about 85° C. During the stretching operation, the film sample may optionally be heated to provide a desired effectiveness of the stretching.

In one particular aspect, the draw or stretching system may be constructed and arranged to generate a draw ratio which is not less than about 2 in the machine and/or transverse directions. The draw ratio is the ratio determined by dividing the final stretched length of the film by the original unstretched length of the film along the direction of stretching. The draw ratio in the machine direction (MD) should not be less than about 2. In another embodiment, the draw ratio is not less than about 2.5 and in yet another embodiment is not less than about 3.0. In another aspect, the stretching draw ratio in the MD is not more than about 11. In another embodiment, the draw ratio is not more than about 7.

When stretching is arranged in the transverse direction, the stretching draw ratio in the transverse direction (TD) is generally not less than about 2. In another embodiment, the draw ratio in the TD is not less than about 2.5 and in yet another embodiment is not less than about 3.0. In another aspect, the stretching draw ratio in the TD is not more than about 11. In another embodiment, the draw ratio is not more than about 7. In yet another embodiment the draw ratio is not more than about 5.

The biaxial stretching, if used, may be accomplished simultaneously or sequentially. With the sequential, biaxial stretching, the initial stretching may be performed in either the MD or the TD.

Desirably, the stretching results in the appearance of micro-tears in the external surface proximate the micron-scale particles. Generally, the individual micro-tears correspond with individual micron-scale particles. The micro-tears may range in size (measured by largest dimension) from about 1 microns to about 100 microns, more specifically from about 1 microns to about 50 microns, and even more specifically from about 1 microns to about 30 microns, and even more specifically from about 1 micron to about 5 microns. The micro-tears may further have a surface density of from about 50 micro-tears per square millimeter to about 500,000 micro-tears per square millimeter, more specifically from about 500 micro-tears per square millimeter to about 350,000 micro-tears per square millimeter, and even more specifically from about 1,000 micro-tears per square millimeter to about 250,000 micro-tears per square millimeter.

Referring to FIG. 3, an exemplary repellant material 10 is shown having an external surface 20. The external surface 20 includes micron-scale particles 30. The external surface 20 further defines micro-tears 40.

During the extrusion process, the micron-scale particles may segregate to the outer surface of the film and form a micron-scale particle-like surface topography. The particle-like surface features formed by the micron-scale particles, such as, for example, calcium carbonate, may range in size (measured by largest dimension) from about 1 micron to about 100 microns. In some embodiments, the particle-like surface features formed by the micron-scale particles may have a surface density of from about 25 to about 250,000 particle-like surface features per square millimeter.

Another method of creating micron-scale topography on the surface of a material is application of a topical micron-scale particle treatment, for example, a coating formulation containing micron-scale calcium carbonate particles. A wetting agent may be used in the treatment formulation to enhance coverage of the surface to be treated. The topical micron-scale particle treatment may be prepared, applied to the surface to be treated, and subsequently dried by techniques known to those skilled in the art, including, for example, dip and squeeze treatment, spray treatment, application with a rod, and so forth.

Nanotopography on an external surface of synthetic polymer films and/or fibers may be achieved by using a smaller internal additive such as a polyhedral oligomeric silsesquioxane (POSS), shown below with R as a functional group. Various functional groups (R) may be added to the POSS molecule, including hydrogen, methyl, ethyl, butyl, isobutyl, and so forth. Various POSS materials are available, for example, from Hybrid Plastics of Hattiesburg, Miss. In one embodiment, the functional group may be an octaisobutyl (OIB) group, thus forming octaisobutyl polyhedral oligomeric silsesquioxane, shown below.

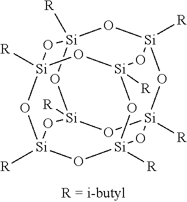

During the extrusion process, the POSS may segregate to the outer surface of the film or fiber and form a particle-like surface nanotopography. The particle-like surface features formed by POSS may range in size (measured by largest dimension) from about 0.1 micron to about 1.0 microns. In some embodiments, the particle-like surface features formed by POSS may have a surface density of from about 1 to about 12 particle-like surface features per square micron.

Further topography on an external surface of polymeric breathable films may also be generated by subjecting the surface to a high-energy surface etching treatment such as a glow discharge from a corona or plasma treatment system. The high energy etching treatment serves to “clean” the synthetic polymeric surface of “loose” weak boundary layers made of contaminants and short chain oligomers. The high energy treatment can also generate radicals on the surface of the laminate, which can subsequently enhance surface attachment through covalent bonding of polymerizing fluorinated monomer. By way of example, the high energy treatment may be a radio frequency (RF) plasma treatment. Alternatively, the high energy treatment may be a dielectric barrier corona treatment. Without wishing to be bound by theory, it is believed that exposure of the polymer surface to a high energy treatment results in alterations of the surfaces, thereby raising the surface energy of the surface and forming radicals that can promote interfacial adhesion and polymerization of fluorinated monomers. These functions are attributed to the high energy treatment through ablation of contaminants, the removal of atoms; and the breaking of bonds that can generate free radicals, polar moieties and ionic species. This, in turn, improves the subsequent uniform deposition of fluorinated compounds onto the surface; that is, the surface may be saturated with fluorinated compounds. Thus, fluorinated compounds can be deposited on the surface of the films on exposed areas.

The strength of the high energy surface treatment may be varied in a controlled manner across at least one dimension of the material. For example, the strength of the high energy treatment can be readily varied in a controlled manner by known means. For example, a corona apparatus having a segmented electrode may be employed, in which the distance of each segment from the sample to be treated may be varied independently. As another example, a corona apparatus having a gap-gradient electrode system may be utilized; in this case, one electrode may be rotated about an axis which is normal to the length of the electrode. Other methods also may be employed; see, for example, “Fabrication of a Continuous Wettability Gradient by Radio Frequency Plasma Discharge”, W. G. Pitt, J. Colloid Interface Sci., 133, No. 1, 223 (1989); and “Wettability Gradient Surfaces Prepared by Corona Discharge Treatment”, J. H. Lee, et al., Transactions of the 17th Annual Meeting of the Society for Biomaterials, May 1-5, 1991, page 133, Scottsdale, Ariz.

The high energy surface treatment may further be achieved by treating the external surface with a gaseous plasma treatment. Inert gases, including argon, helium, nitrogen, and so forth, for example, can be energized to form plasma. Ions and electrons in the plasma can react with the external surface of the synthetic polymer films to create a super-clean or etched surface. Introduction of a reactive gas, such as oxygen, further enhances the ability of the plasma to react with the external surface of the film. The weight ratio of inert gas to reactive gas may range 1 to 4 and 4 to 1. A 1 to 1 weight ratio of argon to oxygen energized to a plasma treatment has been found to be particularly effective in etching of the external surface of polypropylene and polycarbonate materials. The plasma treatment may be conducted, for example, in a 500 Watt plasma chamber (model PS0150E, from Air Coating Technology). The power input may range, for example, from about 100 to about 500 Watts over an exposure time, for example, from about 1 to about 4 minutes.

Once the micron-scale topography is formed and after the high energy surface treatment has been completed, the material having a high degree of micron-scale topography may be chemically treated with reactive plasma to provide the final super-hydrophobic surface. The surface having a high degree of micron-scale topography is subjected to deposition of monomer compounds that are subsequently grafted to the surface via irradiation from a radiation source (e.g., electron beam, gamma, and UV radiation and glow discharge plasma). The monomer compounds are, in one particular embodiment, fluorinated compounds. The monomer deposition process generally involves (1) atomization or evaporation of a liquid fluorinated compound (e.g., a fluorinated monomer, fluorinated polymers, perfluorinated polymers, and the like) in a vacuum chamber, (2) depositing or spraying the fluorinated compound on the surface having the high degree of micron-scale topography, and (3) polymerization of the fluorinated compound by exposure to a radiation source, such as electron beam, gamma radiation, or ultraviolet radiation.

Exemplary fluorinated monomers include 2-propenoic acid, 2,2,3,3,4,4,5,5,6,6,7,7,8,8,8-pentadecafluorooctyl ester; 2-propenoic acid, 2-methyl-2,2,3,3,4,4,5,5,6,6,7,7,8,8,8-pentadecafluorooctol ester; 2-propenoic acid, pentafluoroethyl ester; 2-propenoic acid, 2-methyl-pentafluorophenyl ester; 2,3,4,5,6-Pentafluorostyrene; 2-Propenoic acid, 2,2,2-trifluoroethyl ester; and 2-propenoic acid, 2-methyl-2,2,2-trifluoroethyl ester. Other suitable monomers include fluoroacrylate monomers having the general structure of the following Formula 1:

CH₂═CROCO(CH₂)ₓ(CₙF₂ₙ₊₁)

wherein n is an integer ranging from 1 to 12, x is an integer ranging from 1 to 8, and R is H or an alkyl group with a chain length varying from 1 to 16 carbons. In many instances, the fluoroacrylate monomer may be comprised of a mixture of homologues corresponding to different values of n. An example of a suitable fluoroacrylate monomer is perfluorodecyl acrylate (PFDEA) (available as CAS No. 27905-45-9 from Aldrich), which was used for all the plasma fluorochemical deposition in the examples below. Other suitable monomers are 1H,1H,2H,2H-heptadecafluorodecyl acrylate and 3,3,4,4,5,5,6,6,7,7,8,8,9,9,10,10,10-heptadecafluorodecyl methacrylate.

Monomers of this type may be readily synthesized by one of skill in the chemical arts by applying well-known techniques. Additionally, many of these materials are commercially available. The DuPont Corporation of Wilmington, Del. sells a group of fluoroacrylate monomers under the trade name ZONYL®. These agents are available with different distributions of homologues. More desirably, ZONYL® agents sold under the designation “TA-N” and “TM” may be used in the practice of the present invention.

Additionally, variations of these materials are commercially available from many other sources such as for example, fluoroacrylate monomers under the trade names Capstone® 62-AC and Capstone® 62-MA (DuPont Corporation of Wilmington, Del.) and Unidyne® TG 20 and Unidyne® TG 30 (Daikin Americas, Inc. of Orangeburg, N.Y.) may be used in the practice of the present invention.

In one particular embodiment, the perfluoroalkyl(alkyl)(meth)acrylate polymer is a homopolymer (i.e., containing only a single type of perfluoroalkyl(alkyl)(meth)acrylate monomer). Alternatively, the perfluoroalkyl(alkyl)(meth)acrylate polymer can be a copolymer formed through a mixture of perfluoroalkyl(alkyl)(meth)acrylate monomers corresponding to different values of y and/or z within the ranges given below with respect to Formula 1. As such, in these embodiments, perfluoroalkyl(alkyl)(meth)acrylate polymer can be substantially free from monomers outside of the Formula 1 (i.e., the perfluoroalkyl(alkyl)(meth)acrylate polymer includes greater than about 99% by weight perfluoroalkyl(alkyl)(meth)acrylate monomers according to Formula 1).

However, in other embodiments, the perfluoroalkyl(alkyl)(meth)acrylate polymer can be a copolymer formed from a perfluoroalkyl(alkyl)(meth)acrylate monomer(s), as in Formula 1, combined with other types of monomers (e.g., other (meth)acrylic monomers).

It should be also recognized that the fluorinated polymeric coating may be highly branched and grafted (e.g., covalently bonded) to the fibers (e.g., crosslinked to the polymeric material of the fibers) upon polymerization.

No matter the particular fluorinated agent used, the fluorinated agent is evaporated (or atomized) and condensed (or sprayed) on the surface having the high degree of micron-scale topography according to a monomer deposition process. One particularly suitable monomer deposition process is described by Mikhael, et al. in U.S. Pat. No. 7,157,117, which is incorporated by reference to the extent that it does not conflict with the present application. In this monomer deposition process, a conventional vacuum chamber is modified to enable a plasma-field pretreatment, followed by monomer deposition, and then radiation curing of a porous substrate in a continuous process. Typically, the material being processed is processed entirely within a vacuum chamber while being spooled continuously between a feed reel and a product reel. The material can first be passed through a cold compartment to chill it to a temperature sufficiently low to ensure the subsequent cryo-condensation of the vaporized fluorinated agent. The material is then passed through a plasma pretreatment unit and can immediately thereafter (within no more than a few seconds, preferably within milliseconds) pass through a flash evaporator,- where it is exposed to the fluorinated agent vapor for the deposition of a thin liquid film over the cold material. The fluorinated agent film is then polymerized by radiation curing through exposure to an electron beam unit and passed downstream through another (optional) cooled compartment.

Films may also be plasma treated with silicon containing precursors such as hexamethyldisiloxane (HMDSO). In one embodiment, a film may be first plasma treated with HMDSO and then with fluoroacrylate monomers of Formula 1. Doing so results in a thin layer of silica followed by a thin layer of fluorine-containing species being bound to the film surface. The thickness of each plasma coating is expected to be on the order of a few atomic layers. Desirably, the plasma fluorination is performed last such that the fluorine-containing species would be available to lower the film surface energy.

Exposure to the electron beam after depositing the fluorinated agent of Formula 1 on the surface of the material being treated results in the grafting of the fluorinated agent to the substrate. One exemplary electron beam apparatus is manufactured under the trade designation CB 150 ELECTROCURTAIN® by Energy Sciences Inc. of Wilmington, Mass. This equipment is disclosed in U.S. Pat. Nos. 3,702,412; 3,769,600; and 3,780,308; which are hereby incorporated by reference. Although electron beam radiation is generally preferred, other radiations sources could be utilized, such as gamma radiation or ultraviolet radiation.

Generally, the material being treated may be exposed to an electron beam operating at an accelerating voltage from about 80 kilovolts to about 350 kilovolts, such as from about 80 kilovolts to about 250 kilovolts. In one particular embodiment, the accelerating voltage is about 175 kilovolts. The material being treated may be irradiated from about 0.1 million rads (Mrad) to about 20 Mrad, such as from about 0.5 Mrad to about 10 Mrad. Particularly, the substrates may be irradiated from about 1 Mrad to about 5 Mrad.

As stated, the applied radiation causes a reaction between the deposited fluorinated agent and polymers of the film surface. As a result, the fluorinated agent may become graft copolymerized (or grafted) and/or crosslinked to the surface of the polymer film having the high degree of micron-scale topography. This particular combination of post-treatment adds a high degree of water repellency to the surface having the high degree of micron-scale topography.

Accordingly, the present inventors have found that the treated material can exhibit a contact angle of greater than about 130 degrees. Even more desirably, the present inventors have found that the treated material can exhibit a contact angle of greater than about 140 degrees, i.e., a contact angle essentially equivalent to that of a lotus leaf.

If desired, the highly repellent material of the present invention may be applied with various other treatments to impart desirable characteristics. For example, the highly repellant material may be treated with colorants, antifogging agents, lubricants, and/or antimicrobial agents.

The highly repellant breathable film of the present invention may be used in a wide variety of applications. For example, the highly repellant material may be incorporated into a “medical product”, such as gowns, surgical drapes, facemasks, head coverings, surgical caps, shoe coverings, sterilization wraps, warming blankets, heating pads, and so forth. In some embodiments, the highly repellent material may be laminated to a nonwoven fabric and incorporated into the product as a film/nonwoven laminate. Exemplary nonwovens include spunbond, meltblown, coform, airlaid, bonded carded webs, and so forth, and laminates thereof. Of course, the highly repellant material may also be used in various other articles. For example, the highly repellant material may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipes, and so forth; medical absorbent articles, such as garments, fenestration materials, underpads, bed pads, bandages, absorbent drapes, and medical wipes; food service wipers; clothing articles; pouches, and so forth. Materials and processes suitable for forming such articles are well known to those skilled in the art. Absorbent articles, for instance, typically include a substantially liquid-impermeable layer (e.g., outer cover), a liquid-permeable layer (e.g., bodyside liner, surge layer, etc.), and an absorbent core. In one embodiment, for example, the highly repellant material of the present invention may be used to form an outer cover of an absorbent article.

Although the basis weight of the highly repellant material of the present invention may be tailored to the desired application, it generally ranges from about 10 to about 300 grams per square meter (“gsm”), in some embodiments from about 25 to about 200 gsm, and in some embodiments, from about 40 to about 150 gsm.

### Test Methods

Contact angle measurements were made on samples of material cut to about 2.54 centimeters wide by 7.62 centimeters long. The sample's were placed on a flat metal platform with horizontal and vertical adjustment features. Drops of distilled water (distilled to 18.2 Mflcm using a Milli-Q Water Purification System available from Millipore of Billerica, Mass.) or isopropyl alcohol (IPA) were manually delivered from a 100 microliter syringe to the surface of the sample. Side images of the drops of water on the sample surface were obtained with a camera (Leica Z6 APO A optical zoom system from Leica Microsystems) that was interfaced to a computer via a SONY camera control unit. Auxiliary lighting probes were used to improve the image of the drop. The contact angle at the water/surface interface may be measured from the photo using a standard method, e.g., a protractor.

The WVTR (water vapor transmission rate) value of may be determined using the test procedure standardized by INDA (Association of the Nonwoven Fabrics Industry), number IST-70.4-99, entitled “STANDARD TEST METHOD. FOR WATER VAPOR TRANSMISSION RATE THROUGH NONWOVEN AND PLASTIC FILM USING A GUARD FILM AND VAPOR PRESSURE SENSOR”, which is incorporated herein in its entirety by reference thereto for all purposes. The INDA test procedure is summarized as follows. A dry chamber is separated from a wet chamber of known temperature and humidity by a permanent guard film and the sample material to be tested. The purpose of the guard film is to define a definite air gap and to quiet or still the air in the air gap while the air gap is characterized. The dry chamber, guard film, and the wet chamber make up a diffusion cell in which the test film is sealed. The sample holder is known as the Permatran-W Model 100K manufactured by Mocon/Modem Controls, Inc., Minneapolis, Minnesota. A first test is made of the WVTR of the guard film and the air gap between an evaporator assembly that generates 100% relative humidity. Water vapor diffuses through the air gap and the guard film and then mixes with a dry gas flow that is proportional to water vapor concentration. The electrical signal is routed to a computer for processing. The computer calculates the transmission rate of the air gap and the guard film and stores the value for further use.

The transmission rate of the guard film and air gap is stored in the computer as CalC. The sample material is then sealed in the test cell. Again, water vapor diffuses through the air gap to the guard film and the test material and then mixes with a dry gas flow that sweeps the test material. Also, again, this mixture is carried to the vapor sensor. The computer then calculates the transmission rate of the combination of the air gap, the guard film, and the test material. This information is then used to calculate the transmission rate at which moisture is transmitted through the test material according to the equation:

TR-1_{test.material}=TR-1_{test material, guardfilm, airgap}−TR-1_{guardfilm, airgap}

The water vapor transmission rate (“WVTR”) is then calculated as follows:

WVTR=Fₚₛₐₜ(T)RH/APₛₐₜ(T)(1-RH)

wherein,

F=the flow of water vapor in cm³ per minute;

psat(T)=the density of water in saturated air at temperature T;

RH=the relative humidity at specified locations in the cell;

A=the cross sectional area of the cell; and

Pₛₐₜ(T)=the saturation vapor pressure of water vapor at temperature T.

### EXAMPLES

The inventive materials and methods of making them are exemplified by the following examples. As with the figures, the examples are not meant to be limiting.

Table 1 summarizes two series of NB blown films. The same material was utilized for Layer B in all films; this material being a CaCO₃ filled polyolefin used to create a microporous, breathable core. The polyolefin used for Layer A was varied as specified by Table 1. For the samples 3 and 4, approximately 56 wt % CaCO₃ was added to Layer A to increase breathability.

TABLE 1
Series of microporous A/B films

| | Layer A | | |
|---|---|---|---|
| Sample | (1.25 wt. %) | Layer B (98.75 wt. %) | Notes |
| 1 | Composition 1 | Composition 2 (68 wt. %) and | No CaCO₃ |
| | (Control) | linear low density polyethylene | in skin. |
| | | (Dowlex 2047 available from | |
| | | the Dow Chemical Company of | |
| | | Midland, MI) (32 wt. %) | |
| 2 | Composition 1 | Composition 2 (68 wt. %) and | No CaCO₃ |
| | with 10 wt % | linear low density polyethylene | in skin |
| | POSS | (Dowlex 2047) | |
| 3 | -Composition 3 | Composition 2 (68 wt. %) and | CaCO₃ |
| | (Control) | linear low density polyethylene | in skin. |
| | | (Dowlex 2047) | |
| 4 | Composition 3 | Composition 2 (68 wt. %) and | CaCO₃ |
| | with 10 wt % | linear low density polyethylene | in skin |
| | POSS | (Dowlex 2047) | |

Composition 1 included 0.075 wt. % antioxidant Tris (2,4-di-tert-butylphenyl)phosphite (Irgafos 168 available from BASF Group of Freeport, Tex.), 0.075 wt. & antioxidant Octadecyl-3-(3,5-di-tert.butyl-4-hydroxyphenyl)-propionate(Irganox 1076 available from BASF Group of Freeport, Tex.), 0.04 Wt. % process aid organo silicone (Silquest PA-lavailable from Momentive Performance Chamicals of Wilton Conn,), 25 wt. % ethyl vinyl acetate)Escorene LD761 available from ExxonMobil Chemical Company of Houston, Tex.), 25 wt. % ethyl vinyl acetate (Escorene LD755 available from ExxonMobil Chemical Company), and 49.81 wt. % polypropylene ( Polypropylene Z108NGY available from LyondellBasell Polymers of Houston, Tex.) Composition 2 was a CaCO₃ concentrate consisting of 25 wt. % linear low density polyethylene (Dow 2517 available from The Dow Chemical Company of Midland, Mich.) and 75 wt. % CaCO₃ particles (FL-2029 available from Imerys Group of Paris, France.

Composition 3 was 56% wt. % CaCO₃ particles (FL-2029 from Imerys Group), 35.81 wt. % 12 MFR polypropylene (KS-359P available from LyondellBasell), 8 wt. % 6 MFR ethylene-propylene random copolymer (6D82 RCP available from The Dow Chemical Company), 1000 ppm antioxidant Octadecyl-3-(3,5-di-tert.butyl-4-hydroxyphenyl)-propionate(Irganox 1076 available from BASF Group), 600 ppm Mississippi Lime CaO, and 300 ppm antioxidant Tris (2,4-di-tert-butylphenyl)phosphite (Irgafos 168 available from BASF Group).

In addition, an octaisobutyl POSS (Polyhedral Oligomeric Silsesquioxane® available from Hybrid Plastics of Hattiesburg, Miss.) was added at varying percentages to Layer A, as specified by Table 1. It was hypothesized that POSS would phase separate to the surface of the films and create a novel topography that, when combined with a means to lower surface energy, would result in greater hydro- and/or oleo-phobicity. In that each film, and more specifically Layer A, was comprised of both organic (polymeric) and inorganic (POSS and CaCO3) regions, a sample of each film was plasma etched in an O₂ environment. The films were positioned such that the surface of Layer A was exposed to the O₂ plasma. It was conjectured the O₂ plasma would etch away the organic material, leaving behind a topography enhanced by the inorganic rich regions.

Samples of the films in Table 1, both etched and unetched, were then plasma treated. Etched and unetched films were first plasma treated with hexamethyldisiloxane (HMDSO) and then with perfluorodecyl acrylate (PFDEA). Doing so resulted in a thin layer of silica followed by a thin layer of layer fluorine-containing species being bound to the film surface. Unetched films were also plasma treated solely with perfluorodecyl acrylate (PFDEA). The thickness of each plasma coating is expected to be on the order of a few atomic layers. The films were positioned such that the surface of Layer A was plasma treated in each case. Plasma fluorination was always performed last such that the fluorine-containing species would be available to lower the film surface energy.

Contact angles of deionized H₂O and 100% isopropyl alcohol (IPA) droplets were measured for each film surface (i.e., Layer A) to determine changes in fluid repellency. A multivariate standard least squares analysis was performed in fitting the data and identifying statistically significant. trends and/or comparisons. Experimental observations are summarized as follows.

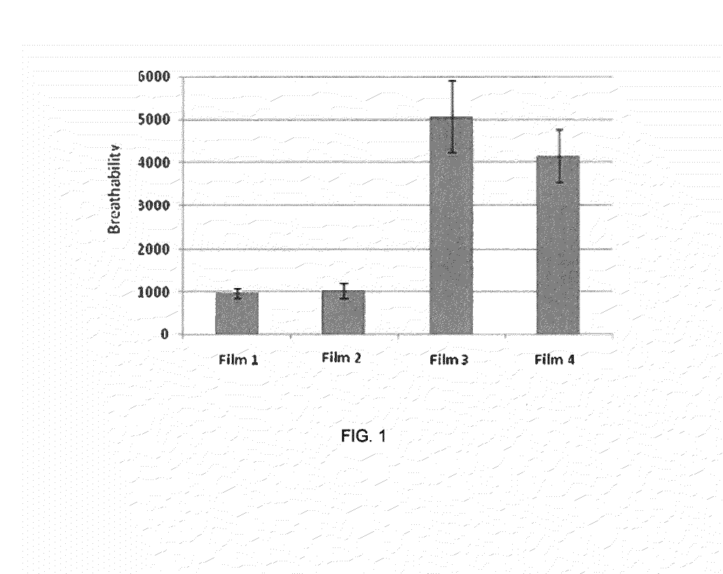

Referring to FIG. 1, all films were found to have some measure of breathability, with the samples 3 and 4 having comparatively greater breathability.

As extruded (i.e., no plasma treatment), all films wet out against 100% IPA, effectively resulting in an average IPA contact angle of 0 degrees and no statistically significant effects between films. Some inherent repellency of the as-extruded films to H₂O was present, however. Contact angle was found to be statistically dependent upon film type. Specifically, contact angles ranged from 97±5 degrees on Film 1 to 104±5 degrees on Film 3. The presence of POSS did not influence H₂O contact angle. Comparing Films 1 and 3, two major differences exist in Layer A; CaCO₃ wt % and the polymeric material used. Thus, contact angle could potentially be dependent upon differences in surface energies of the polymers themselves and/or the presence of CaCO₃. Without being held by theory, the inventors believe that the presence of CaCO₃ is the primary factor.

Layer A polymer(s) used for Films 1 and 3 were a polypropylene/ethylene vinyl acetate (EVA) copolymer blend and a thermoplastic propene-ethylene copolymer, respectively. It is reasoned the surface energies of these two polymer systems should range, at most, between 30.1 mN/m reported for 100% isotactic polypropylene and 36.5mN/m reported for 100% polyvinyl acetate. In actuality, surface energies should be intermediate to these two values, in that both copolymers in either system are copolymers of ethylene, for which the surface energy of the homopolymer is ˜35 mN/m. In addition, the EVA copolymer is physically blended with -50% by weight of polypropylene. Thus, both polymer systems are likely to have surface energies closer to that of polypropylene and/or polyethylene.

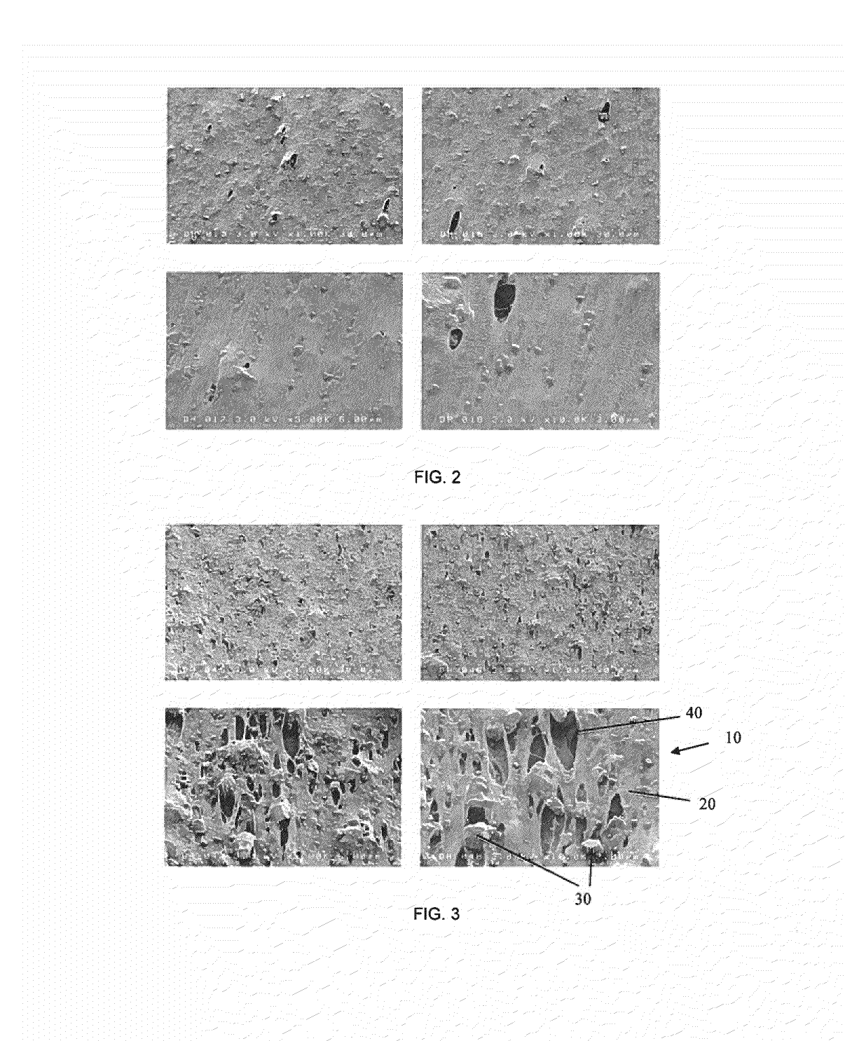

The differences in contact angle between Films 1 and 3 are more likely influenced by the presence of CaCO₃, or some resulting consequence of its presence. FIG. 2 depicts surface SEMs of Layer A from Film 1. FIG. 3 depicts surface SEMS of Layer A from Film 3. Referring to FIGS. 2 and 3, Film 3 (FIG. 3) is visually more rough (and more porous) than Film 1 (FIG. 2), due to the presence of CaCO₃ in Layer A. In addition, present in Film 3 is an exposed CaCO₃ particle surface. It is more likely that the measured contact angle is being influenced by these physical differences than the relatively minor differences in polymer surface energy between Films 1 and 3.

Films 1 and 3 were then plasma treated as described above. Plasma treatment effectively modified the surface energy of the films to be that of a fluorinated hydrocarbon. Thus, any differences in surface energy resulting from different polymer systems would, in effect, be buried under an atomic layer of fluorinated species, resulting in the films having equivalent surface energy.

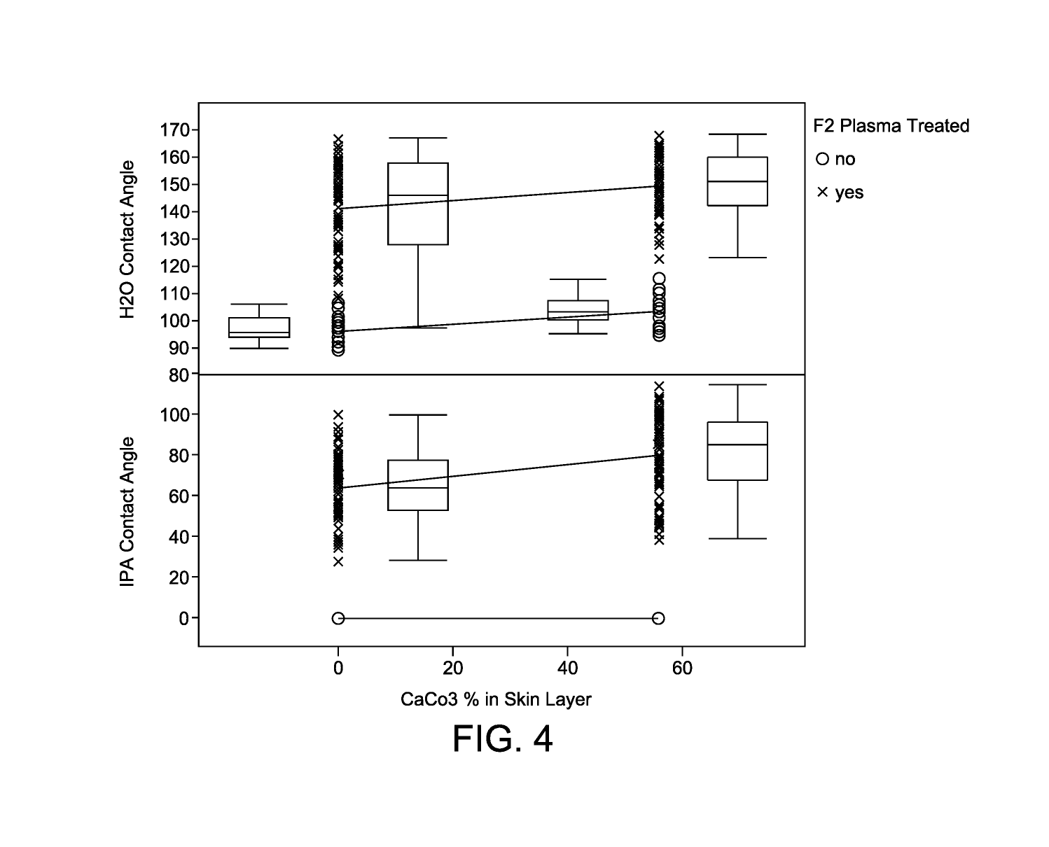

Upon plasma fluorination of the films, average IPA and H₂O contact angles increased significantly. IPA contact angle on Film 1 increased effectively from 0 to 62±4 degrees upon fluorination. H₂O contact angle on Film 1 increased from 97±5 to 129±4 degrees. Similarly, on Film 3, IPA contact angle increased from effectively 0 degrees to 80±4 upon fluorination, while H₂O contact angle increased from 104±5 to 144±4 degrees. Both IPA and H₂O contact angle were found to be a function of film type (e.g., Film 1 vs. Film 3). More specifically, contact angles of both fluids were, as on untreated films, greater on Film 3 than on Film 1. In that both film surfaces should have equivalent surface energies due to plasma treatment, the difference in contact angle is attributed to the presence of CaCO₃ and, in particular, the surface topography that results. The differences in contact angle as a function of plasma treatment and CaCO₃ wt % are depicted in FIG. 4 for Films 1 and 3.

Furthermore, the interaction between CaCO₃ and plasma fluorination was found to be statistically significant for both H₂O and IPA contact angle, suggesting an “amplification” effect. I.e., upon lowering surface energy through fluorination, the effect of CaCO₃ topography is enhanced leading to more dramatic increases in contact angle per unit amount of CaCO₃ added.

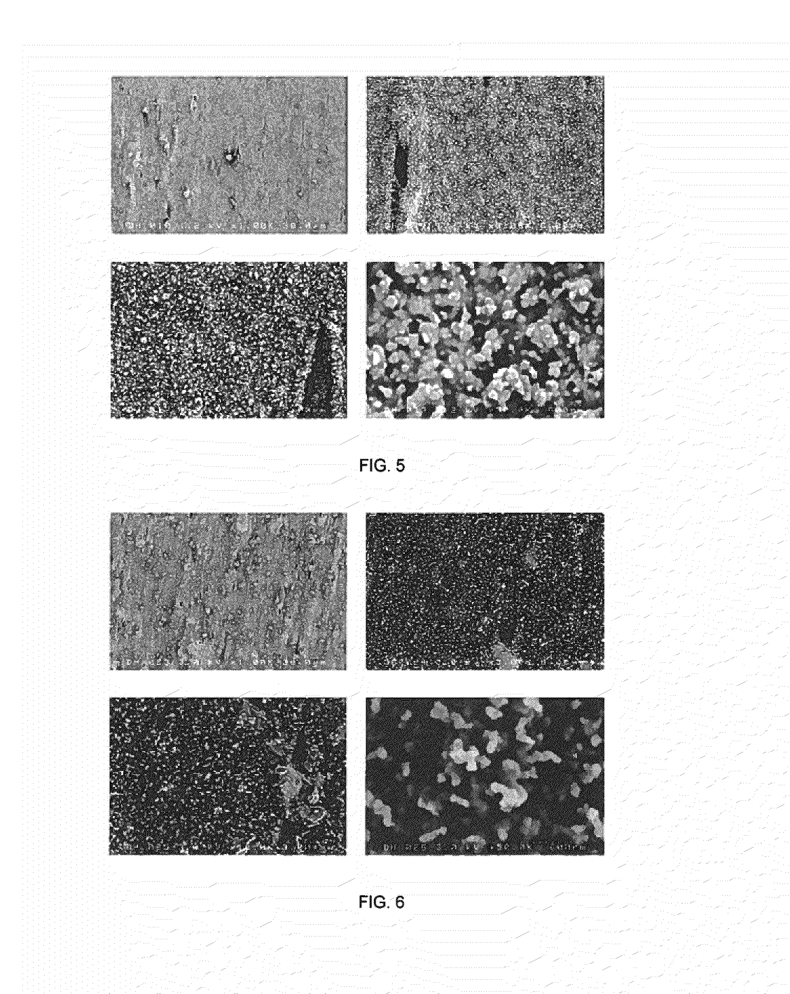

The change in topography due to plasma fluorination is illustrated in FIGS. 5 and 6. Referring to FIGS. 5 and 6, comparing these images to those of the untreated films depicted in FIGS. 2 and 3, it is apparent plasma treatment imparted topography in the range of ˜1 μm while not removing the topography already present in the ˜10 μm range. The increase in contact angle of high and low surface energy fluids is attributed to this newly imparted topography, coupled with the lower surface energy due to fluorination.

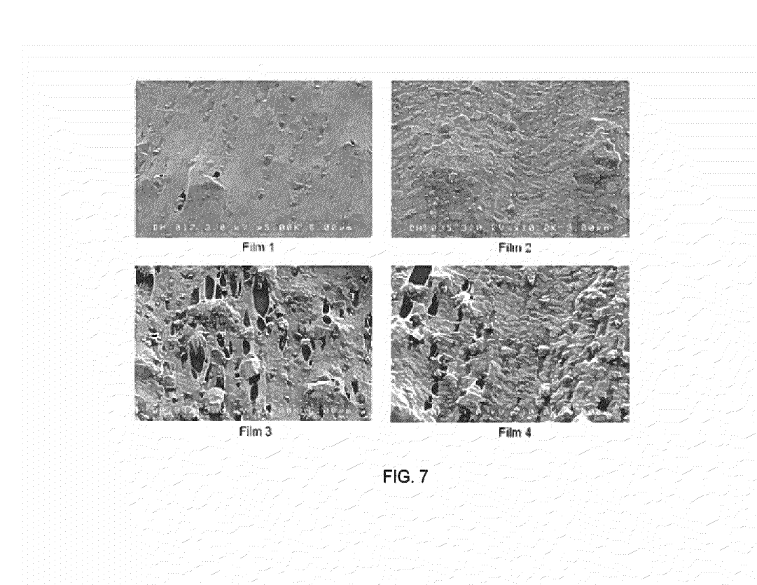

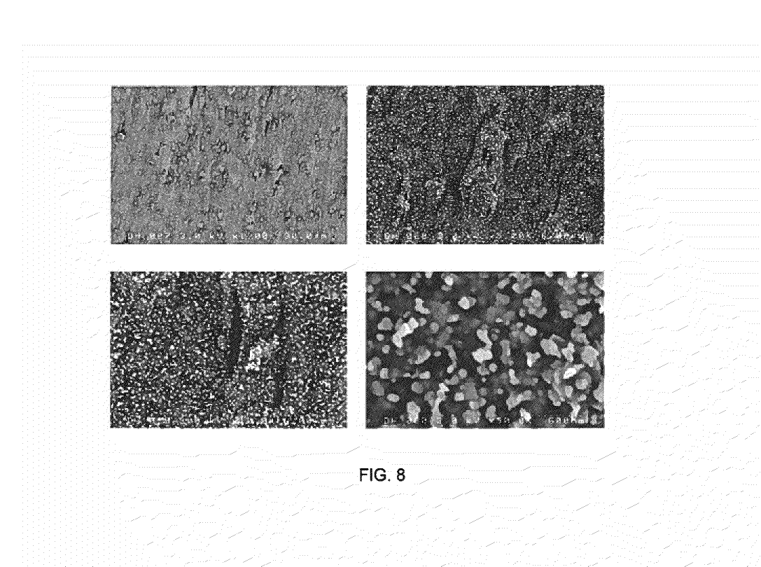

The effect of the presence of POSS on contact angle was found to be nonexistent for H₂O and small for IPA, even though SEM images from films show different surface morphology resultant from POSS phase separation, as depicted in FIG. 7. FIG. 7 depicts SEMs of unfluorinated film Layer A surfaces with and without POSS. The lack of a statistical effect on the part of POSS addition is explained by FIG. 8. FIG. 8 depicts the changes to surface morphology, set up by the addition of POSS prior to fluorination, which were destroyed during fluorination.

Depositing a layer of SiOx via plasma prior to plasma fluorination was found to bring about additional effects on contact angle. With IPA, depositing SiOx prior to plasma fluorination was found to have a relatively minor effect. However, with H2O, depositing SiOx prior to plasma fluorination was found to increase contact angle as compared to plasma fluorination alone. For example, in Film 1, where CaCO₃ was not added to Layer A, depositing SiOx prior to plasma fluorination increased H₂O contact angle from 129±4 to 150±3 degrees. Similar to the plasma fluorinated films, the presence of CaCO3 in Layer A was found to increase contact angle in the SiOx/fluorinated films. Specifically, comparing Film 1 to Film 4, contact angles for H₂O and IPA were found to increase from 150±3 and 74±5 to 154±3 and 92±5 degrees, respectively.

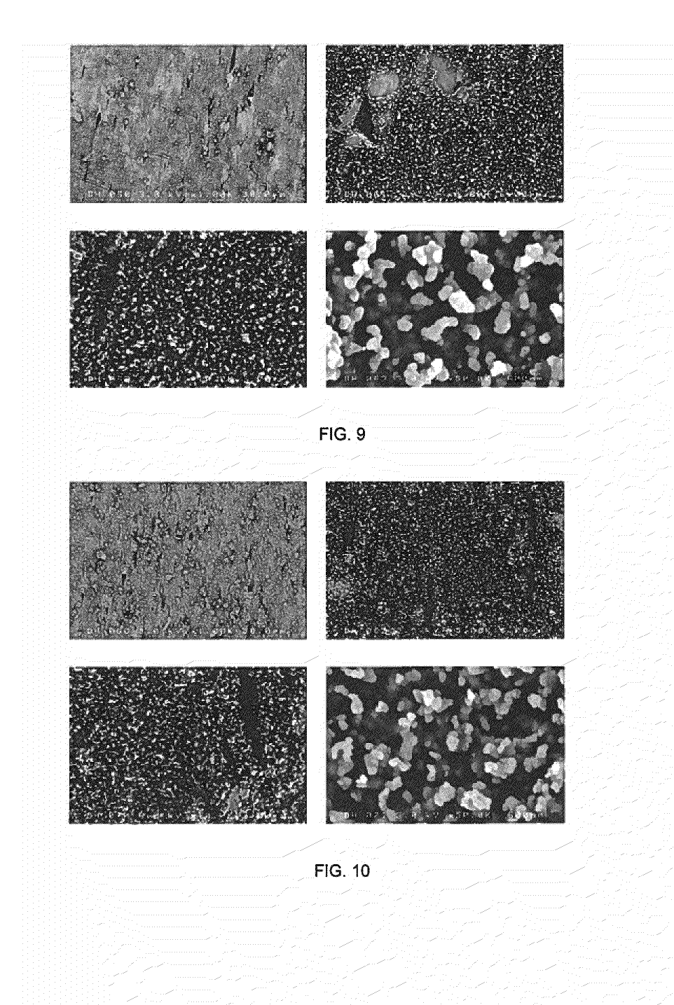

Plasma etching of the films, prior to SiOx/fluorination, was also found to have a significant effect in increasing contact angle of IPA. From the SEM images of FIG. 9 it is evident plasma etching resulted in enhanced topography. In particular, changes in topography are evident due to the presence of CaCO₃ and POSS, relative to Film 2 and 4 in FIG. 7.

Plasma etching was found to result in the largest increase in IPA contact angle, relative to an un-etched film, when POSS and/or CaCO₃ were at the highest levels. Without POSS or CaCO₃ in Layer A, plasma etching resulted in minimal increase in contact angle. Conversely, the addition of CaCO₃ to plasma etched films was found to have a larger impact on contact angle than adding an equivalent amount of CaCO₃ to an un-etched film. As an illustration, in comparing un-etched films, IPA contact angle increased approximately 18 degrees upon addition of 56 wt % CaCO₃ to Layer A, while it increased approximately 27 degrees upon addition of 56 wt % CaCO₃ to Layer A in etched films. The interaction between CaCO₃ wt % and plasma etching was found to be significant, strongly suggesting this observation of “amplification” is not a statistical anomaly.

Comparatively, plasma etching was not found to have a significant effect on H₂O contact angle. Upon plasma etching and fluorination, the H₂O contact angle values approach that of a superhydrophobic material (i.e., ˜150 degrees) and are close to the theoretical maximum of 180 degrees. As performance approaches this theoretical maximum, it is likely the “amplification” effect of CaCO₃, seen with IPA, would be suppressed for H₂O as a result since values greater than 180 cannot be achieved physically.

The change in topography due to plasma etching before plasma fluorination is illustrated in FIGS. 9 and 10. Comparing these images to those of unetched films as depicted in FIGS. 5 and 6, it is apparent plasma etching has etched away surface polymer leaving more numerous and more exaggerated pores visible in both Film 1 (FIG. 9) and Film 3 (FIG. 10), in addition to leaving behind and further exposing CaCO₃. The further increase in contact angle of low surface energy IPA is attributed to this topography exaggerated by plasma etching. IPA and H₂O contact angles have been found to be dependent upon plasma fluorination, consistent with prior work. More so, IPA and H₂O contact angles have been demonstrated to be enhanced (increased) upon incorporation of CaCO₃ into the surface layer. This is particular useful, in that CaCO₃ is commonly added to impart microporosity to the films upon stretching. Furthermore, enhancement to contact angle occurs when the surface layer of the film is loaded with CaCO3, or topography is present by some other means (e.g., POSS), and the film is etched prior to fluorination. It is highly probable these enhancements to IPA and H₂O contact angle are due to modifications to surface topography that take place in the presence of CaCO₃, and which are amplified upon plasma etching.

While the embodiments of the invention disclosed herein are presently preferred, various modifications and improvements can be made without departing from the spirit and scope of the invention. The scope of the invention is indicated by the appended claims, and all changes that fall within the meaning and range of equivalents are intended to be embraced therein.

1.-21. (canceled)

22. A high repellency thermoplastic polymer film comprising:
a blend of thermoplastic polymer and particles wherein the particles comprise greater than 40 percent, by weight, of the film and wherein the film has a porous morphology;
the external surface of the film having micro-tears proximate the particles and further having particle-scale topography comprising particle-like surface features ranging in size between about 1 and 100 microns;
the particle-scale topography having thereon a second topography having a smaller scale than the particle scale topography.

23. The film of claim 22 wherein the particles comprise inorganic particles selected from the group consisting of calcium carbonate, barium sulfate, sodium carbonate, magnesium carbonate, magnesium sulfate, barium carbonate, kaolin, carbon, carbon black, graphite, graphene, calcium oxide, magnesium oxide, aluminum hydroxide, titanium dioxide, talc, mica, and wollastonite.

24. The film of claim 23, wherein the particle-like surface features have a size of between about 1 and 30 microns.

25. The film of claim 24, wherein the polymer is a thermoplastic polyolefin.

26. The film of claim 25 wherein the second topography is created by plasma deposition.

27. The film of claim 26, wherein the second topography has thereon a fluorochemical applied by plasma deposition.

28. The film of claim 27, wherein the film comprises a silica-containing layer between the fluorochemical and the second topography.

29. The film of claim 28, wherein the silica-containing layer is applied by plasma deposition.

30. The film of claim 27 wherein the external surface of the film demonstrates a contact angle to isopropyl alcohol of greater than 60 degrees.

31. The film of claim 30, wherein the film demonstrates a Water Vapor Transmission Rate (WVTR) of greater than 1000 grams per square meter per day.

32. An article comprising the film of claim 22 wherein the article is selected from the group consisting of garments, surgical drapes, facemasks, shoe coverings, sterilization wraps, bed pads, warming blankets, heating pads, bandages, incontinence articles, and feminine hygiene products.

33. A method of forming a liquid repellant film comprising:
blending micron-sized particles with a thermoplastic base polymer to form a blend;
extruding said blend into a film;
stretching the film from about 100 to about 1000 percent of its original length thereby forming a breathable film with a porous morphology and micro-tears in the external surface of said film proximate the particles; and
etching the external surface of said stretched film with a high energy surface treatment; wherein said film has particle-like surface features having a size, in the largest dimension, of between about 1 and 100 microns and further wherein said film has a WVTR greater than 1000 g/M²/day.

34. The method of claim 33 wherein the inorganic particles comprise greater than 40 percent, by weight, of said film wherein the particle-like surface features have a size, in the largest dimension, of between about 1 and about 30 microns .

35. The method of claim 34 wherein the micron-sized particles are selected form the group consisting of calcium carbonate, barium sulfate, sodium carbonate, magnesium carbonate, magnesium sulfate, barium carbonate, kaolin, carbon, carbon black, graphite, graphene, calcium oxide, magnesium oxide, aluminum hydroxide, titanium dioxide, talc, mica, and wollastonite.

36. The method of claim 35 wherein the inorganic particles are calcium carbonate particles.

37. The method of claim 35 wherein the etching step comprises subjecting the external surface of the stretched film to a glow discharge from a corona or plasma treatment system.

38. The method of claim 37 further comprising the step of depositing a fluorochemical onto the etched external surface by a plasma fluorination process.

39. The method of claim 38 further comprising the step of depositing a silica containing layer to the film prior to etching.

40. The method of claim 38 wherein the fluorinated film has a WVTR greater than 1000 g/M2/day.

41. The method of claim 40 wherein the external surface of the fluorinated film demonstrates a contact angle to water of greater than 125 degrees and a contact angle to isopropyl alcohol of greater than 60 degrees.
